(19) United States
(12) Patent Application Publication
(10) Pub. No.: US 2019/0026193 A1
(43) Pub. Date: Jan. 24, 2019

(54) METHOD AND APPARATUS FOR EXECUTING DATA RECOVERY OPERATION

(71) Applicant: ALIBABA GROUP HOLDING LIMITED, George Town (KY)

(72) Inventor: Xiaowen ZHENG, Hangzhou (CN)

(73) Assignee: ALIBABA GROUP HOLDING LIMITED

(21) Appl. No.: 16/137,473

(22) Filed: Sep. 20, 2018

Related U.S. Application Data
(63) Continuation of application No. PCT/CN2017/076036, filed on Mar. 9, 2017.

(30) Foreign Application Priority Data
Mar. 22, 2016 (CN) 201610166586.8

(51) Int. Cl. G06F 11/14; G06F 17/30

(52) U.S. Cl. CPC G06F 11/1469; G06F 2201/82; G06F 2201/80; G06F 17/30368

(57) ABSTRACT

A method and an apparatus for executing a data recovery operation are provided. The method includes: acquiring identification information of a first change log to be recovered to; searching for the first change log according to the identification information; and recovering a second change log to the first change log according to user data information and metadata information that are recorded in the second change log and user data information and metadata information that are recorded in the first change log, wherein multiple change logs exist between the second change log and the first change log.

### CROSS REFERENCE TO RELATED APPLICATION

The present disclosure claims the benefits of priority to International Patent Application number PCT/CN2017/076036, filed Mar. 9, 2017, and Chinese Patent Application No. 201610166586.8, filed Mar. 22, 2016, both of which are incorporated herein by reference in their entireties.

### TECHNICAL FIELD

The embodiments of the present disclosure relate to computers, and in particular, to a method and an apparatus for executing a data recovery operation in computers.

### BACKGROUND

An Open Data Processing Service (ODPS) is a distributed massive data processing platform independently developed by ALIYUN. The ODPS provides rich data processing functions and flexible programming frameworks and is applied to fields such as data analysis, mining, and business intelligence. The ODPS uses an abstract job processing framework to unify various computing tasks in different scenarios on the same platform, so that the computing tasks share security, storage, data management, and resource scheduling. As such, a uniform programming port and interface are provided for various data processing tasks from different user requirements.

Metadata refers to information that describes data attributes and is used for supporting functions such as storage location indication, historical data, resource search, file recording and so on. In other words, metadata is data about other data, or structured data for providing related information of a certain type of resource. Metadata is used for identifying a resource, evaluating a resource, and tracking changes of a resource in a use process, so as to achieve easy and efficient management of a large quantity of networked data and achieve effective discovery, search, and integrated organization of information resources as well as effective management of used resources. Metadata mainly has the following basic characteristics:
(a) metadata can be shared once established. The structure and integrity of the metadata rely on the value and a use environment of information resources. A development and utilization environment of metadata is usually a changing distributed environment. No single format can completely meet different requirements of different groups.
(b) metadata is an encoding system for describing digital information resources, especially network information resources. This results in a fundamental difference between metadata and a conventional data encoding system. The most important feature and function of metadata is to establish a machine-understandable framework for digital information resources.

A metadata system constructs a logic framework and a basic model of e-government affairs, thus determining functional features, operational modes, and overall performance of system operation of the e-government affairs. All operations of the e-government affairs are implemented based on metadata, which mainly have a description function, an integration function, a control function, and an agent function.

Metadata is also data, and therefore can also be stored in and acquired from a database by using a method similar to that for data. If an organization providing a data element also provides a metadata of the data element, use of the data element will become accurate and efficient. When using the data element, a user can first view the metadata of the data element to acquire required information.

Currently, a data versioning system in a large-scale or a super-large-scale data set scenario already exists in a distributed data processing platform system. Through the system, a user can easily implement operations such as recovering data, restoring a time point, undoing a change, redoing data, and so on.

FIG. 1 is a schematic diagram illustrating a process of generating a data version management record by a distributed data processing platform system provided in conventional art. As shown in FIG. 1, a distributed data processing platform system employs a chained data recovery manner in a data recovery process, and data recovery operations depend on each other. In other words, if a user needs to recover an earlier version, it is necessary to roll back sequentially to the specified version according to a current Change Log (which refers to a change log of data operations and can be used for data recovery) record.

For example, Table 1 is an example of performing data recovery in a chained data recovery manner in conventional art.

TABLE 1

| LogId | Type | Time | Operation | Status |
|---|---|---|---|---|
| 1452216975272855351 | TABLE | 2016-01-08 | CREATE | UNDOABLE |
| | | 09:36:15 | | |
| 1452216989166724482 | TABLE | 2016-01-08 | DROP | UNAVAILABLE |
| | | 09:36:29 | | |
| 1452217464192642287 | TABLE | 2016-01-08 | DROP | UNAVAILABLE |
| | | 09:44:24 | | |
| 1452217542349594080 | TABLE | 2016-01-08 | DROP | UNAVAILABLE |
| | | 09:45:42 | | |
| 1452218243795766348 | TABLE | 2016-01-08 | DROP | REDOABLE |
| | | 09:57:23 | | |
| 1452407548091196381 | TABLE | 2016-01-10 | OVERWRITE | UNDOABLE |
| | | 14:32:28 | | |
| 1452407625046628818 | TABLE | 2016-01-10 | OVERWRITE | UNDOABLE |
| | | 14:33:45 | | |
| 1452407726812625638 | TABLE | 2016-01-10 | OVERWRITE | UNDOABLE |
| | | 14:35:26 | | |
| 1452407775639627693 | TABLE | 2016-01-10 | OVERWRITE | UNDOABLE |
| | | 14:36:15 | | |

Using Table 1 above as an example, the data recovery manner used in conventional art is usually completed based on a changelog mechanism in a distributed database, and a specific implementation process thereof is as follows:
Step 1: a user views a currently recorded data version of a table by using an instruction having a log record query function.
Step 2: if the user specifies a particular changelog Id (1452216975272855351) and uses an instruction having a log record rollback function, it is necessary to start a data recovery mechanism to recover to a specified version.
Step 3: scan a version record of the table to acquire all operation records between the current state and the specified version, and sequentially generate a recovery plan in a reverse order. As shown in Table 1, when the user specifies a recovery to a data version of 1452216975272855351, it is necessary to sequentially recover each version in a reverse order from 1452407775639627693, until the version of 1452216975272855351 is recovered.
Step 4: start recovery according to the generated recovery plan. The recovery is implemented by operating processing logic of data and metadata sequentially.

The current data version and recovery mechanism are both a job in essence, in which data and metadata will be operated. This seems the same as a user job and final processing of an internal cross-cluster copy job in terms of principle.

However, in conventional recovery mechanisms, recovery needs to be performed in a reverse order from a current status, until a specified version is recovered. The example above simply lists a small amount of data versions thereof. If online table operations are performed excessively frequently, there are possibly tens of thousands of intermediate statuses between the data version of 1452407775639627693 and the data version of 1452216975272855351. That is, thousands of operations may need to be processed sequentially during the process of recovering a specified version.

Currently, massive data processing platforms (e.g., data warehouses such as HIVE) provided in conventional art do not have a management module for data recovery. A solution employed by a conventional database (e.g., MYSQL) is to acquire and save difference data of each operation, so that recovery can be performed according to the stored difference data in a process of performing a subsequent recovery operation. This causes great dependency in a massive data processing system, and the data recovery is highly complex and highly risky.

Thus, the data recovery manner used in conventional art causes technical difficulties such as complexity of data recovery, data inconsistency, high failure rate of data recovery and data loss due to mismatching between data and metadata. In addition, such a reverse-order recovery manner also greatly increases the overheads of required recovery time.

The manner of recovering data in a reverse order based on versions may cause a significant increase in the recovery time. Moreover, this data recovery behavior needs to be completed through a series of operations on data and metadata, thus increasing the complexity of user operations. In addition, this data recovery manner may also increase a conflict probability of mechanisms such as a system internal replication mechanism, thus increasing the possibility of a user operation exception or a recovery exception, bringing about a data recovery failure risk. Currently, no effective solution has been put forward for the foregoing problems.

### SUMMERY OF THE DISCLOSURE

Embodiments of the present disclosure provide a method and an apparatus for executing a data recovery operation, so as to at least partially solve the technical problems existing in conventional art that in a recovery mechanism of a distributed data processing platform system, a specified target change log can be recovered from the current latest change log only after sequential rollback of multiple intermediate change logs, and the operation is relatively complex and easily causes data loss.

According to some embodiments of the present disclosure, a method for executing a data recovery operation is provided, the method including: acquiring identification information of a first change log to be recovered to; searching for the first change log according to the identification information; and recovering the first change log from a second change log according to user data information and metadata information that are recorded in the second change log and as well as user data information and metadata information that are recorded in the first change log, wherein multiple change logs exist between the second change log and the first change log.

Optionally, recovering the second change log further comprises: parsing out first original user data and first original metadata from the first change log; parsing out second original user data and second original metadata from the second change log; recovering the second original user data to the first original user data; and recovering the second original metadata to the first original metadata.

Optionally, recovering the second change log to the first change log further comprises: parsing out modified user data and modified metadata from the second change log; recovering the modified user data to the first original user data; and recovering the modified metadata to the first original metadata, wherein the modified user data and the modified metadata are obtained by modifying, according to a type of an operation to modify an object recorded in the second change log, second original user data and second original metadata that are recorded in the second change log.

Optionally, searching for the first change log further comprises: acquiring change log list information by adding a list name into a change log query command or acquiring change log partition information by adding a partition name into a change log query command, and searching for the first change log in the change log list information or the change log partition information according to the identification information; or searching for the first change log by adding a list name and the identification information into a change log query command or adding a partition name and the identification information into a change log query command.

Optionally, acquiring identification information of the first change log further comprises: receiving a control instruction for triggering a data recovery operation, wherein the control instruction carries the identification information; performing an authentication operation on the control instruction; and acquiring the identification information from the control instruction when the authentication succeeds.

Optionally, after recovering the second change log, the method further comprises: returning a prompt information corresponding to the control instruction, wherein the prompt information is used for representing that the second change log has been successfully recovered to the first change log.

According to some embodiments of the present disclosure, an apparatus for executing a data recovery operation comprising: a memory storing a set of instructions; and a processor configured to execute the set of instructions to cause the apparatus to perform: acquiring identification information of a first change log to be recovered to; searching for the first change log according to the identification information; and recovering a second change log to the first change log according to user data information and metadata information that are recorded in the second change log as well as user data information and metadata information that are recorded in the first change log, wherein multiple change logs exist between the second change log and the first change log.

Optionally, the processor further executes the set of instructions to cause the apparatus to perform: parsing out first original user data and first original metadata from the first change log; and parsing out second original user data and second original metadata from the second change log; recovering the second original user data to the first original user data; and recovering the second original metadata to the first original metadata.

Optionally, the processor further executes the set of instructions to cause the apparatus to perform: parsing out first original user data and first original metadata from the first change log; and parsing out modified user data and modified metadata from the second change log; recovering the modified user data to the first original user data; and recovering the modified metadata to the first original metadata, wherein the modified user data and the modified metadata are obtained by modifying, according to a type of an operation to modify an object recorded in the second change log, second original user data and second original metadata that are recorded in the second change log.

Optionally, the processor further executes the set of instructions to cause the apparatus to perform: acquiring change log list information by adding a list name into a change log query command or acquiring change log partition information by adding a partition name into a change log query command; or searching for the first change log in the change log list information or the change log partition information according to the identification information; or searching for the first change log by adding a list name and the identification information into a change log query command or adding a partition name and the identification information into a change log query command.

Optionally, the processor further executes the set of instructions to cause the apparatus to perform: receiving a control instruction for triggering a data recovery operation, wherein the control instruction carries the identification information; performing an authentication operation on the control instruction; and acquiring the identification information from the control instruction when the authentication succeeds.

Optionally, the processor further executes the set of instructions to cause the apparatus to perform: returning a prompt information corresponding to the control instruction, wherein the prompt information is used for representing that the second change log has been successfully recovered to the first change log.

In some embodiments of the present disclosure, a manner of recovering the current latest change log to a specified target change log by only executing one recovery operation is employed. A latest change log is directly recovered to a target change log according to user data information and metadata information that are recorded in the latest change log as well as user data information and metadata information that are recorded in the target change log, while a processing procedure of sequential rollback of multiple to-be-undone change logs existing between the latest change log and the target change log is omitted, thus achieving the technical effects of reducing operation complexity of a distributed database recovery mechanism, improving a success rate of the distributed database recovery mechanism, and reducing time overheads of the distributed database recovery mechanism. As such, the embodiments of the present disclosure solve the technical problems existing in conventional art that in a recovery mechanism of a distributed data processing platform system, a current latest change log can be recovered to a specified target change log only after sequential rollback of multiple intermediate change logs, and the operation is relatively complex and easily causes data loss.

### BRIEF DESCRIPTION OF THE DRAWINGS

The accompanying drawings described here are used to provide further comprehension of the present disclosure, and constitute a part of the present disclosure. The exemplary embodiments of the present disclosure and the description thereof are used to illustrate the present disclosure, and do not limit the present disclosure improperly. In the drawings:

FIG. 1 is a schematic diagram illustrating a process of generating a data version management record by a distributed data processing platform system in conventional art;

FIG. 2 is a schematic block diagram illustrating exemplary hardware of a computer terminal for a method for executing a data recovery operation, consistent with some embodiments of the present disclosure;

FIG. 3 is a flowchart providing an exemplary method for executing a data recovery operation, consistent with some embodiments of the present disclosure;

FIG. 4 is a schematic diagram illustrating an exemplary comparison between different log change record querying manners, consistent with some embodiments of the present disclosure;

FIG. 5 is a schematic block diagram illustrating an exemplary apparatus for executing a data recovery operation, consistent with one exemplary embodiments of the present disclosure;

FIG. 6 is a schematic block diagram illustrating an exemplary apparatus for executing a data recovery operation, consistent with another exemplary embodiments of the present disclosure; and

FIG. 7 is a schematic block diagram illustrating an exemplary computer terminal, consistent with some embodiments of the present disclosure.

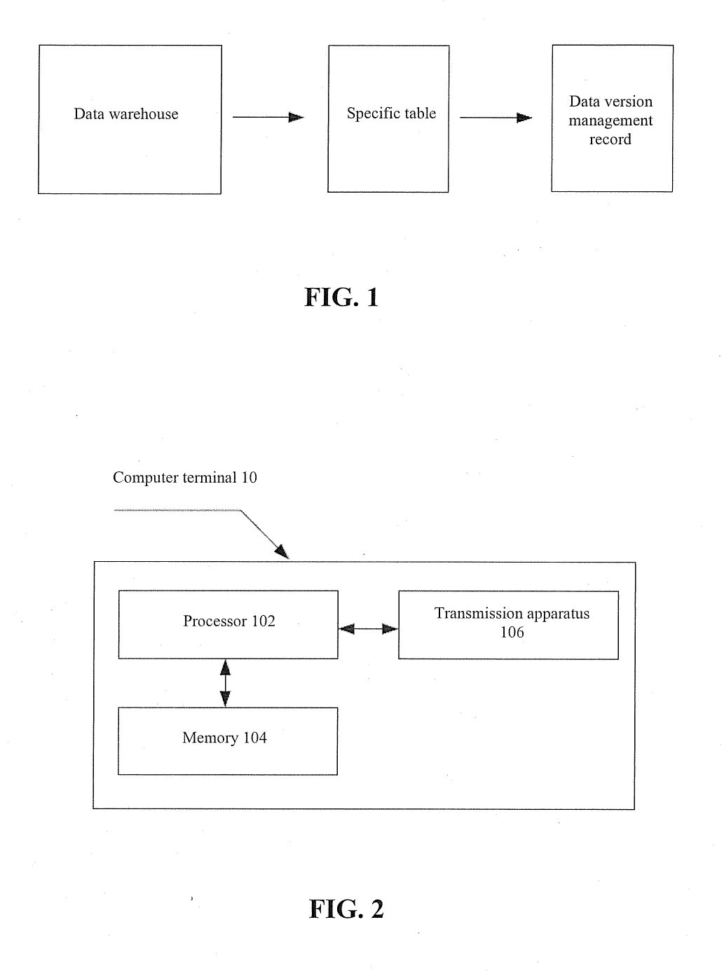

### DETAILED DESCRIPTION

To make those skilled in the art better understand the present disclosure, the embodiments of the present disclosure are described in the following with reference to the accompanying drawings. Apparently, the described embodiments are merely some, rather than all, of the embodiments of the present disclosure. Based on the embodiments of the present disclosure, other embodiments obtained by those of ordinary skill in the art without creative efforts should belong to the protection scope of the present disclosure.

It should be noted that the relational terms such as “first” and “second” in the specification, claims, and the foregoing accompanying drawings of the present disclosure are merely used to distinguish similar objects and are not necessarily used to describe a specific sequence or order. It should be understood that data used in such a manner can be exchanged in a proper case, so that the embodiments of the present disclosure can be implemented in sequences other than the sequences depicted or described here. In addition, the terms “include,” “comprise” or their other variations are intended to cover non-exclusive inclusion. For example, a process, method, system, product or device including a series of steps or units is not necessarily limited to the steps or units clearly listed but may include other steps or units not listed or include steps or units inherent to the process, method, product or device.

According to some embodiments of the present disclosure, a method for executing a data recovery operation is provided. It should be noted that steps shown in the flowchart of the accompanying drawings can be executed in a computer system such as a group of computer executable instructions. Moreover, although a logic sequence is shown in the flowchart, the depicted or described steps can be executed in a sequence different from the sequence here in some cases.

The disclosed method may be executed in a mobile terminal, a computer terminal or a similar arithmetic unit. Using running on a computer terminal as an example, FIG. 2 is a schematic block diagram illustrating exemplary hardware of a computer terminal for a method for executing a data recovery operation, consistent with some embodiments of the present disclosure. As shown in FIG. 2, a computer terminal 10 includes one or more (only one is shown in the figure) processors 102. Processor 102 may be, but is not limited to, a microprocessor MCU, a programmable logic device FPGA or other processing apparatuses. Computer terminal 10 further includes a memory 104 configured to store data, and a transmission apparatus 106 for a communication function. It is appreciated that the structure shown FIG. 2 is merely an example and does not limit the structure of the foregoing electronic apparatus. For example, the computer terminal 10 may further include components more or fewer than those shown in FIG. 2 or have a configuration different from that shown in FIG. 2.

Memory 104 may be configured to store a software program and a module of application software, for example, a program instruction/module corresponding to the method for executing a data recovery operation, consistent with some embodiments of the present disclosure. Processor 102 is configured to run the software program and the module stored in memory 104 to execute various functional applications and data processing, that is, to implement the foregoing method for executing a data recovery operation. Memory 104 may be a high-speed random access memory, or a non-volatile memory such as one or more magnetic storage apparatuses, flash memories, or other non-volatile solid-state memories. In some exemplary embodiments, memory 104 may further include memories remotely disposed with respect to processor 102. The remote memories can be connected to computer terminal 10 through a network. Examples of the foregoing network include, but are not limited to, the Internet, an enterprise intranet, a local area network, a mobile communications network, and their combinations.

Transmission apparatus 106 is configured to receive or send data through a network. Specific examples of the foregoing network may include a wireless network provided by a communication provider of computer terminal 10. For example, transmission apparatus 106 includes a Network Interface Controller (NIC), which can be connected to other network devices through a base station and thus can communicate with the Internet. In some exemplary embodiments, transmission apparatus 106 may be a Radio Frequency (RF) module, which is configured to communicate with the Internet in a wireless manner.

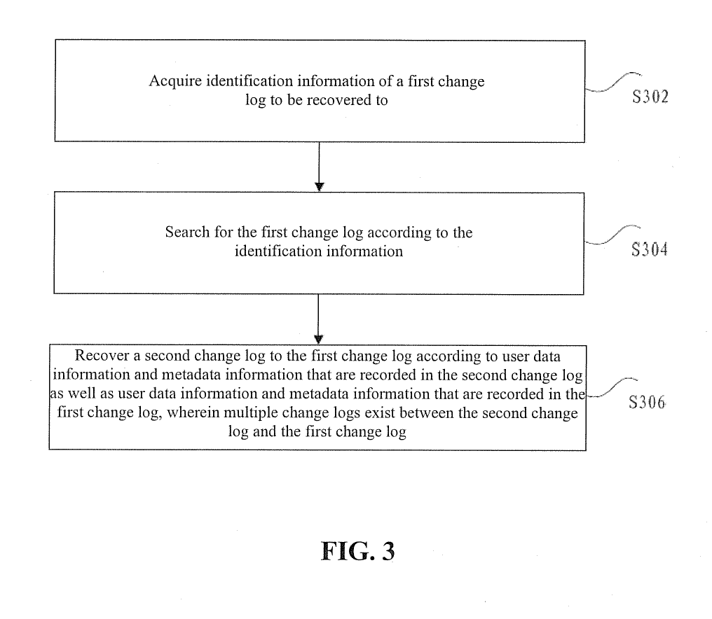

In the foregoing operation environment, the present disclosure provides a method for executing a data recovery operation as shown in FIG. 3. FIG. 3 is a flowchart illustrating an exemplary method for executing a data recovery operation, consistent with embodiments of the present disclosure. As shown in FIG. 3, in step S302, identification information of a first change log to be recovered to is acquired. In step S304, the first change log is searched for according to the identification information. In step S306, a second change log is recovered to the first change log according to user data information and metadata information that are recorded in the latest second change log as well as user data information and metadata information that are recorded in the first change log, wherein multiple to-be-undone change logs exist between the second change log and the first change log.

Through the technical solution provided by the embodiments of the present disclosure, a manner of recovering the current latest change log (equivalent to the foregoing second change log) to a specified target change log (equivalent to the foregoing first change log) only by executing one recovery operation is employed. A latest change log is directly recovered to a target change log according to user data information and metadata information that are recorded in the latest change log as well as user data information and metadata information that are recorded in the target change log, while a processing procedure of sequential rollback of multiple to-be-undone change logs existing between the latest change log and the target change log is omitted, thus achieving the technical effects of reducing operation complexity of a distributed database recovery mechanism and improving a success rate of the distributed database recovery mechanism. As such, the embodiments of the present disclosure are capable of solving the technical problems existing in conventional art that in a recovery mechanism of a distributed data processing platform system, the current latest change log can be recovered to a specified target change log only after sequential rollback of multiple intermediate change logs, and the operation is relatively complex and easily causes data loss.

In a process of executing data processing by using the distributed data processing platform system, data is usually deleted by mistake or overwritten by mistake due to misoperations. Therefore, a data version management recovery module (such as ChangeLogs) of the distributed data processing platform system provides a massive data versioning mechanism and a data recovery tool. That is, the data version management recovery module can be used to undo massive data or recover to any historical version of data, and view modified content of each version. Therefore, the data version management recovery module can recover data in time after the data is deleted by mistake or overwritten by mistake, so as to ensure security of data maintenance.

According to a retention time of the data version management recovery module, it can be determined whether a function of the data version management recovery module is enabled. For example, when the retention time of the data version management recovery module is less than a preset duration, it indicates that the function of the data version management recovery module is disabled, and the data version management recovery module is not recorded. When the retention time of the data version management recovery module is greater than or equal to the preset duration, it indicates that the function of the data version management recovery module is enabled currently, and the data version management recovery module will be recorded automatically. In the range of the retention time of the data version management recovery module, any modification operation that has been executed can be recovered immediately.

Each change log in the data version management recovery module completely records a type of an operation to modify a table or partition, a user, a query, environment information, original metadata and full-data snapshots as well as modified metadata and full-data snapshots. A user may use the data version management recovery module to execute operations such as rollback or data recovery.

Optionally, step S306 may include a step in which first original user data and first original metadata are parsed out from the first change log. The user data information recorded in the first change log includes: the first original user data and the first original metadata before a modification operation corresponding to an operation type included in the first change log is executed on a processing object (partition or list) as well as modified user data and modified metadata after the modification operation corresponding to the operation type included in the first change log is executed. If a current latest change log needs to be recovered to a change log specified by a user, the final result is that user data information and metadata information in the current latest change log are recovered to the first original user data and the first original metadata that exist before the modification operation corresponding to the operation type included in the first change log is executed on the processing object (partition or list). Therefore, the first original user data and the first original metadata need to be parsed out (or extracted from) the first change log. That is, the target object to be recovered to is the first original user data and the first original metadata.

Optionally, step S306 may further include a step in which second original user data and second original metadata are parsed out from the second change log, the second original user data is recovered to the first original user data, and the second original metadata is recovered to the first original metadata; or modified user data and modified metadata are parsed out from the second change log, the modified user data is recovered to the first original user data, and the modified metadata is recovered to the first original metadata, wherein the modified user data and the modified metadata are obtained by modifying, according to a type of an operation to modify an object recorded in the second change log, original user data and original metadata that are recorded in the second change log.

With respect to the foregoing target object to be recovered to, a source object of recovery may be second original user data and second original metadata before a modification operation corresponding to an operation type included in the second change log is executed on the processing object (partition or list), or may be modified user data and modified metadata after the modification operation corresponding to the operation type included in the second change log is executed. Therefore, once the target object to be recovered to and the source object of recovery are determined, with only one data recovery operation, the second original user data can be directly recovered to the first original user data and the second original metadata can be directly recovered to the first original metadata; or the modified user data can be recovered to the first original user data and the modified metadata can be recovered to the first original metadata.

For example, a user executes a first operation on ALIPAY at 2016-01-08 09:36:15, and a personal account is created. At this point, a first change record is generated. User data information of the first change record mainly includes: user, 2016-01-08 09:36:15, specific amount (0 Yuan) in the newly created account. Corresponding metadata information mainly includes: user name, creation time, account balance, and other information for describing user data attributes. Because the account is a newly created account, the balance of the newly created account is 0 Yuan.

If the user executes a second operation at 2016-01-08 09:57:23 to deposit 200 Yuan RMB into the newly created ALIPAY account, at this point, a second change record is generated. User data information of the second change record mainly includes: user, 2016-01-08 09:57:23, specific amount (200 Yuan) in the newly created account, and RMB. Corresponding metadata information mainly includes: user name, creation time, account balance, currency and other information for describing user data attributes.

If the user executes a third operation at 2016-01-09 09:52:20 to withdraw 50 Yuan RMB from the newly created ALIPAY account, a third change record is generated at this point. User data information of the third change record mainly includes: user, 2016-01-09 09:52:20, specific amount (150 Yuan) in the newly created account, and RMB. Corresponding metadata information mainly includes: user name, creation time, account balance, currency and other information for describing user data attributes. Through this operation, the current change record may include: original user data (user, 2016-01-08 09:57:23, 200 Yuan and RMB) and original metadata (user name, creation time, account balance and currency) before a modification operation is performed on a user account storage record table; and modified user data (user, 2016-01-09 09:52:20, 150 Yuan and RMB) and modified metadata (user name, creation time, account balance and currency) after the modification operation is performed on the user account storage record table.

After N-1 operations in the middle, if the user executes an N^{th} operation at 2016-01-10 14:32:28 and needs to exchange 100 Yuan RMB in the account into Japanese Yen, an N^{th} change record is generated at this point. Metadata information of the N^{th} change record may further need to include an exchange rate attribute based on the existing attribute information such as the user name, creation time, account balance, and currency. Correspondingly, Yen data and an exchange rate value (1 RMB=17.4825 Yen) are added under the currency attribute of the user data information in addition to RMB. Through this operation, the current change record can include: original user data (user, 2016-01-10 09:40:50, 200 Yuan and RMB) and original metadata (user name, creation time, account balance and currency) before the modification operation is performed on the user account storage record table; and modified user data (user, 2016-01-10 14:32:28, 200 Yuan, RMB and Yen) and modified metadata (user name, creation time, account balance, currency and exchange rate) after the modification operation is performed on the user account storage record table.

If the user needs to recover the N^{th} change record to the third change record, first of all, the original user data (user, 2016-01-08 09:57:23, 200 Yuan and RMB) and the original metadata (user name, creation time, account balance and currency) before the modification operation is performed on the user account storage record table need to be extracted from the third change record. Next, the original user data (user, 2016-01-10 09:40:50, 200 Yuan and RMB) and the original metadata (user name, creation time, account balance and currency) before the modification operation is performed on the user account storage record table, or modified user data (user, 2016-01-10 14:32:28, 200 Yuan, RMB and Yen) and modified metadata (user name, creation time, account balance, currency and exchange rate) after the modification operation is performed on the user account storage record table are further extracted from the Nth change record. Then, the original user data (user, 2016-01-10 09:40:50, 200 Yuan and RMB) and the original metadata (user name, creation time, account balance and currency) can be recovered to the original user data (user, 2016-01-08 09:57:23, 200 Yuan and RMB) and the original metadata (user name, creation time, account balance and currency), and the modified user data (user, 2016-01-10 14:32:28, 200 Yuan, RMB and Yen) and the modified metadata (user name, creation time, account balance, currency and exchange rate) can also be recovered to the original user data (user, 2016-01-08 09:57:23, 200 Yuan and RMB) and the original metadata (user name, creation time, account balance and currency).

Optionally, step S304 of searching for the first change log according to the identification information may include Manner 1 or Manner 2 as follows:
Manner 1: acquiring change log list information by adding a list name into a change log query command or acquiring change log partition information by adding a partition name into a change log query command and searching for the first change log in the change log list information or the change log partition information according to the identification information. A user of the distributed data processing platform system can query a data version management recovery module of a specific table or partition by using a syntax structure of SHOW CHANGELOGS FOR TABLE<table name>[PARTITION(<partition name>)]. Then, the change record is found from the data version management recovery module of the specific table or partition according to logId.
Manner 2: searching for the first change log by adding a list name and the identification information into a change log query command or adding a partition name and the identification information into a change log query command. A user of the distributed data processing platform system can also directly query a change record of a specific table or partition by using a syntax of SHOW CHANGELOGS FOR TABLE<table name>[PARTITION(<partition name>)]<logId>.

The <logId> above is a unique ID of each data version management recovery module, which is essentially a non-repeated timestamp accurate to nanosecond. It can be seen from the SHOW CHANGELOGS list that when data is deleted or overwritten by mistake due to a misoperation and an exception occurs, a specific change record can be found by using the foregoing two commands, so that the user can find the problem in time and recover a data version.

Optionally, step S302 of acquiring identification information of the first change log may include: (1) a step in which a control instruction for triggering a data recovery operation is received, wherein the control instruction carries the identification information; and (2) a step in which an authentication operation is performed on the control instruction, and the identification information is acquired from the control instruction if the authentication succeeds.

In some embodiments, a user may specify a logId that needs to be recovered to, and may use an UNDO syntax structure (that is, UNDO TABLE<table name>[PARTITION(<partition name>)]TO<logId>) to start the data recovery mechanism. By executing only one data recovery operation, the latest change log can be recovered to the change log that needs to be reserved. Therefore, both partition data and list data that are deleted by mistake or overwritten by mistake can be recovered by using the foregoing command.

After the user specifies the logId that needs to be recovered to and starts the data recovery mechanism, it is necessary to perform distributed data processing platform system authentication on the user to judge whether the user has the right to perform a recovery operation on the change log. If the user has the right to execute the recovery operation on the change log, the logId is acquired from a command that is submitted by the user for triggering the data recovery mechanism. If the user does not have the right to execute the recovery operation on the change log, an alarm is directly sent to the user or the user is rejected to access the data version management recovery module.

Optionally, after the step of recovering a second change log to the first change log according to user data information and metadata information that are recorded in the second change log as well as user data information and metadata information that are recorded in the first change log, the method may further include: returning a prompt information corresponding to the control instruction, wherein the prompt information is used for representing that the second change log has been successfully recovered to the first change log.

After the user specifies the logId that needs to be recovered to and uses an UNDO syntax structure (that is, UNDO TABLE<table name>[PARTITION(<partition name>)]TO<logId>) to start the data recovery mechanism, and then successfully recovers, by executing only one data recovery operation, the latest change log to the change log needing to be recovered to, prompt information indicating that the data recovery operation has been executed successfully and the latest change log has been recovered to the user-specified target change log can be returned to the user. Then the whole data recovery process is ended.

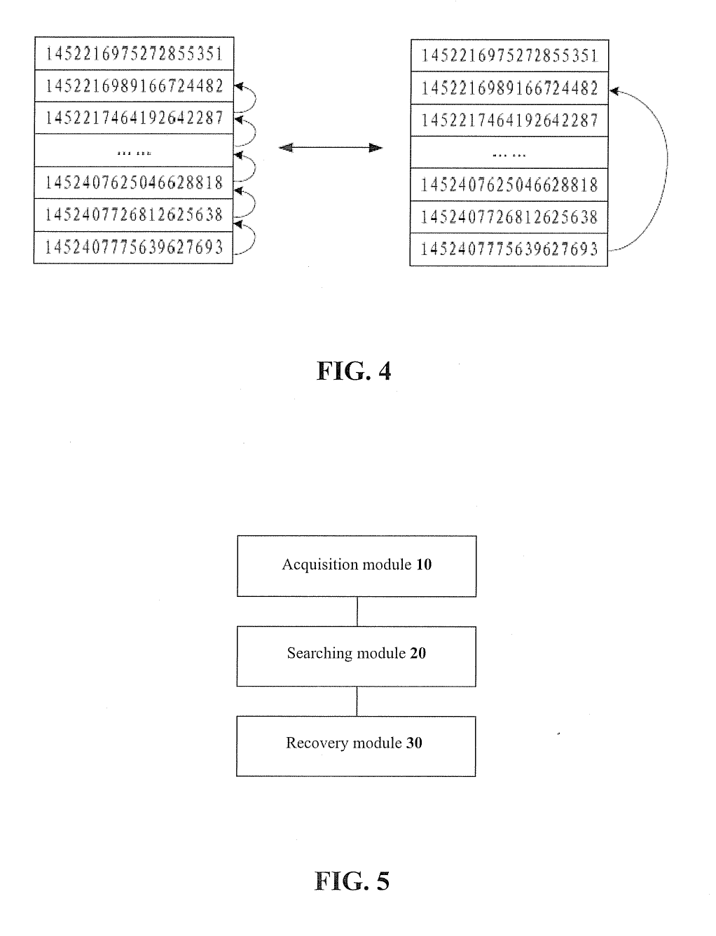

In order to highlight the difference between the technical solution provided by the exemplary embodiments of the present disclosure and conventional solution, a comparison is further made with reference to the example shown in FIG. 4. FIG. 4 is a schematic diagram illustrating a comparison between different log change record querying manners according to some embodiments of the present disclosure. As shown in FIG. 4, it is assumed that the current latest stored log record table includes the following identification information in sequence: 1452216975272855351, 1452216989166724482, 1452217464192642287, . . . , 1452407625046628818, 1452407726812625638, and 1452407775639627693. Assuming that a log record of a version in which the identification information is 1452216989166724482 needs to be recovered to current, the recovery solution provided in conventional art is:
1452407775639627693→1452407726812625638→1452407625046628818→ . . . →414522174 64192642287→1452216989166724482. That is, rollback is performed in turn to 1452216989166724482 according to the record sequence of the change records.

On the other hand, the technical solution provided in some embodiments of the present disclosure is: 1452407775639627693→1452216989166724482. That is, the current latest recorded 1452407775639627693 is directly recovered to the specified version 1452216989166724482.

It should be noted that the foregoing embodiments are all expressed as a series of action combinations for ease of description. However, it is appreciated that the present disclosure is not limited by the described action sequence, because some steps can be performed in other sequences or simultaneously according to the present disclosure. Secondly, it is appreciated that the embodiments described in the present disclosure are all preferred embodiments, and the actions and modules involved are not mandatory to the present disclosure.

According to the description of the foregoing implementations, it is appreciated that the method for executing a data recovery operation according to the foregoing embodiments can be implemented by software plus a necessary hardware platform, or can also be implemented by hardware. In most cases, the former may be a better implementation. Based on such an understanding, the technical solution of the present disclosure can be embodied in the form of a software product. The computer software product is stored in a storage medium (such as a read-only memory (ROM)/random access memory (RAM), a magnetic disk, or an optical disc) and includes several instructions for enabling a terminal device (which can be a mobile phone, a computer, a server, a network device, or the like) to execute the methods in various embodiments of the present disclosure.

According to some embodiments of the present disclosure, an apparatus for implementing executing a data recovery operation is provided. FIG. 5 is a schematic block diagram illustrating an exemplary apparatus for executing a data recovery operation, consistent with embodiments of the present disclosure. As shown in FIG. 5, an apparatus for executing a data recovery operation includes: an acquisition module 10 configured to acquire identification information of a first change log to be recovered to; a searching module 20 configured to search for the first change log according to the identification information; and a recovery module 30 configured to recover a second change log to the first change log according to user data information and metadata information that are recorded in the latest second change log as well as user data information and metadata information that are recorded in the first change log, wherein multiple to-be-undone change logs exist between the second change log and the first change log.

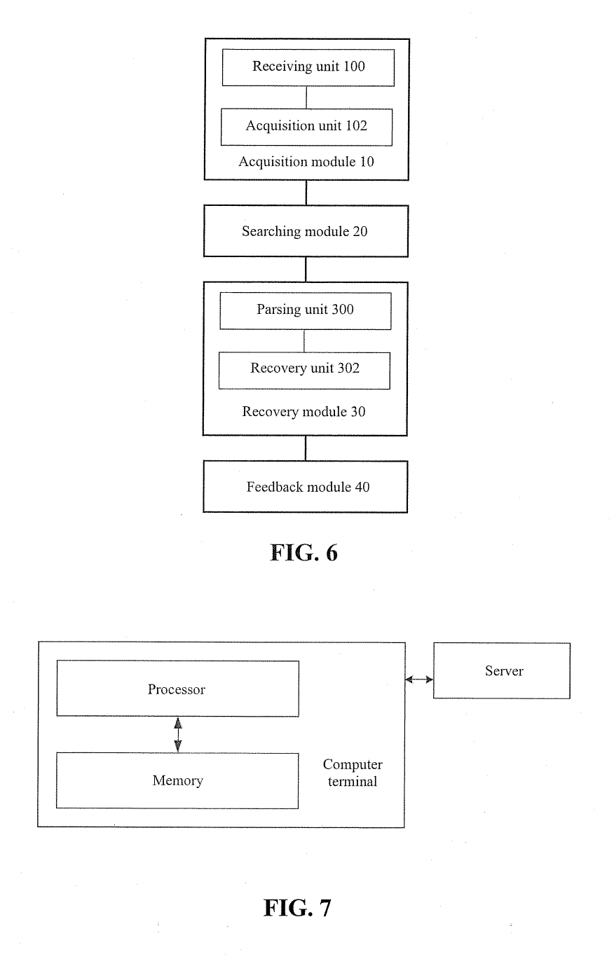

References are now made to FIG. 6, a schematic block diagram illustrating an exemplary apparatus for executing a data recovery operation, consistent with embodiments of the present disclosure. As shown in FIG. 6, an apparatus for executing a data recovery operation includes: an acquisition module 10 configured to acquire identification information of a first change log to be recovered to; a searching module 20 configured to search for the first change log according to the identification information; a recovery module 30 configured to recover a second change log to the first change log according to user data information and metadata information that are recorded in the latest second change log as well as user data information and metadata information that are recorded in the first change log, wherein multiple to-be-undone change logs exist between the second change log and the first change log; and a feedback module 40 configured to return prompt information corresponding to the control instruction, wherein the prompt information is used for representing that the second change log has been successfully recovered to the first change log.

Recovery module 30 further includes: a parsing unit 300 configured to parse out first original user data and first original metadata from the first change log; and a recovery unit 302 configured to parse out second original user data and second original metadata from the second change log, recover the second original user data to the first original user data, and recover the second original metadata to the first original metadata.

Optionally, parsing unit 300 is configured to parse out first original user data and first original metadata from the first change log. Recovery unit 302 is configured to parse out modified user data and modified metadata from the second change log, recover the modified user data to the first original user data, and recover the modified metadata to the first original metadata. The modified user data and the modified metadata can be obtained by modifying, according to a type of an operation to modify an object recorded in the second change log, original user data and original metadata that are recoded in the second change log.

Optionally, searching module 20 is configured to acquire change log list information by adding a list name into a change log query command or acquire change log partition information by adding a partition name into a change log query command. Searching module is further configured to search for the first change log in the change log list information or the change log partition information according to the identification information; or search for the first change log by adding a list name and the identification information into a change log query command or adding a partition name and the identification information into a change log query command.

Optionally, as shown in FIG. 6, acquisition module 10 may further include a receiving unit 100 configured to receive a control instruction for triggering a data recovery operation, wherein the control instruction carries the identification information. Acquisition module 10 may further include an acquisition unit 102 configured to perform an authentication operation on the control instruction and to acquire the identification information from the control instruction if the authentication succeeds.

Some embodiments of the present disclosure may provide a computer terminal. The computer terminal may be any computer terminal device in a computer terminal group. Optionally, the computer terminal may also be replaced with a terminal device such as a mobile terminal. The computer terminal may be at least one network device in multiple network devices located in a computer network.

References are now made to FIG. 7, a schematic block diagram illustrating a computer terminal, consistent with some embodiments of the present disclosure. As shown in FIG. 7, the computer terminal may include one or more (only one is shown) processors and a memory.

The memory may be configured to store a software program and a module, for example, a program instruction/module corresponding to the method and apparatus for executing a data recovery operation in the embodiments of the present disclosure. The processor runs the software program and module stored in the memory to execute various functional applications and data processing; that is, implement the foregoing method for executing a data recovery operation. The memory may include a high-speed random access memory and may further include a non-volatile memory such as one or more magnetic storage apparatuses, flash memories, or other non-volatile solid-state memories. In some examples, the memory can further include memories remotely disposed with respect to the processor. The remote memories may be connected to the terminal through a network. Examples of the network include, but are not limited to, the Internet, an enterprise intranet, a local area network, a mobile communications network, and their combinations.

The processor may call the information and application program stored in the memory through a transmission apparatus to execute the following steps:
S1. Identification information of a first change log to be recovered to is acquired.
S2. The first change log is searched for according to the identification information.
S3. A second change log is recovered to the first change log according to user data information and metadata information that are recorded in the latest second change log as well as user data information and metadata information that are recorded in the first change log, wherein multiple to-be-undone change logs exist between the second change log and the first change log.

Optionally, the processor may further execute program codes of the following steps: parsing out first original user data and first original metadata from the first change log; and parsing out second original user data and second original metadata from the second change log, recovering the second original user data to the first original user data, and recovering the second original metadata to the first original metadata.

Optionally, the processor may further execute program codes of the following steps: parsing out first original user data and first original metadata from the first change log; and parsing out modified user data and modified metadata from the second change log, recovering the modified user data to the first original user data, and recovering the modified metadata to the first original metadata, wherein the modified user data and the modified metadata are obtained by modifying, according to a type of an operation to modify an object recorded in the second change log, original user data and original metadata that are recorded in the second change log.

Optionally, the processor may further execute program codes of the following steps: acquiring change log list information by adding a list name into a change log query command or acquiring change log partition information by adding a partition name into a change log query command, and searching for the first change log in the change log list information or the change log partition information according to the identification information; or searching for the first change log by adding a list name and the identification information into a change log query command or adding a partition name and the identification information into a change log query command.

Optionally, the processor may further execute program codes of the following steps: receiving a control instruction for triggering a data recovery operation, wherein the control instruction carries the identification information; and performing an authentication operation on the control instruction and acquiring the identification information from the control instruction if the authentication succeeds.

Optionally, the processor may further execute program codes of the following step: returning prompt information corresponding to the control instruction, wherein the prompt information is used for representing that the second change log has been successfully recovered to the first change log.

In some embodiments of the present disclosure, a manner of recovering the current latest change log to a specified target change log only by executing one recovery operation is employed. A latest change log is directly recovered to a target change log according to user data information and metadata information that are recorded in the latest change log as well as user data information and metadata information that are recorded in the target change log, while a processing procedure of sequential rollback of multiple to-be-undone change logs existing between the latest change log and the target change log is omitted, thus achieving the technical effects of reducing operation complexity of a distributed database recovery mechanism, improving a success rate of the distributed database recovery mechanism, and reducing time overheads of the distributed database recovery mechanism. As such, some embodiments of the present disclosure solve the technical problems existing in conventional art that in a recovery mechanism of a distributed data processing platform system, the current latest change log can be recovered to a specified target change log only after sequential rollback of multiple intermediate change logs, and the operation is relatively complex and easily causes data loss.

It is appreciated that the structure shown in FIG. 7 is merely an example. The computer terminal may also be a smart phone (such as an Android phone or an iOS phone), a tablet computer, a palmtop computer, and terminal devices such as a Mobile Internet Devices (MID), and PADs. FIG. 7 does not limit the structure of the foregoing electronic apparatus. For example, the computer terminal may further include components (such as a network interface and a display apparatus) more or fewer than those shown in FIG. 7 or may have a configuration different from that shown in FIG. 7.

It is appreciated that all or some steps in the various methods in the foregoing embodiments may be completed by a program instructing related hardware of the terminal device. The program may be stored in a computer readable storage medium. The storage medium may include: a flash disk, a ROM, a RAM, a magnetic disk, an optical disc, or the like.

Some embodiments of the present disclosure further provide a storage medium. Optionally, in these embodiments, the foregoing storage medium may be configured to store program codes executed by the method for executing a data recovery operation provided in the embodiments above.

Optionally, in these embodiments, the storage medium may be any computer terminal in a computer terminal group in a computer network, or any mobile terminal in a mobile terminal group.

Optionally, in these embodiments, the storage medium is configured to store program codes for executing the following steps:
S1. Identification information of a first change log to be recovered to is acquired.
S2. The first change log is searched for according to the identification information.
S3. A second change log is recovered to the first change log according to user data information and metadata information that are recorded in the latest second change log as well as user data information and metadata information that are recorded in the first change log, wherein multiple to-be-undone change logs exist between the second change log and the first change log.

Optionally, in these embodiments, the storage medium is further configured to store program codes for executing the following steps: parsing out first original user data and first original metadata from the first change log; and parsing out second original user data and second original metadata from the second change log, recovering the second original user data to the first original user data, and recovering the second original metadata to the first original metadata.

Optionally, in these embodiments, the storage medium is further configured to store program codes for executing the following steps: parsing out first original user data and first original metadata from the first change log; and parsing out modified user data and modified metadata from the second change log, recovering the modified user data to the first original user data, and recovering the modified metadata to the first original metadata, wherein the modified user data and the modified metadata are obtained by modifying, according to a type of an operation to modify an object recorded in the second change log, original user data and original metadata that are recorded in the second change log.

Optionally, in these embodiments, the storage medium is further configured to store program codes for executing the following steps: acquiring change log list information by adding a list name into a change log query command or acquiring change log partition information by adding a partition name into a change log query command, and searching for the first change log in the change log list information or the change log partition information according to the identification information; and searching for the first change log by adding a list name and the identification information into a change log query command or adding a partition name and the identification information into a change log query command.

Optionally, in these embodiments, the storage medium is further configured to store program codes for executing the following steps: receiving a control instruction for triggering a data recovery operation, wherein the control instruction carries the identification information; and performing an authentication operation on the control instruction, and acquiring the identification information from the control instruction if the authentication succeeds.

Optionally, in these embodiments, the storage medium is further configured to store program codes for executing the following steps: returning prompt information corresponding to the control instruction, wherein the prompt information is used for representing that the second change log has been successfully recovered to the first change log.

The sequence numbers of the foregoing embodiments of the present disclosure are merely for the convenience of description, but do not imply the preference among the embodiments.

In the foregoing embodiments of the present disclosure, the description of the various embodiments have their own focus. For content that is not detailed in a example embodiment, reference can be made to the relevant description of other embodiments.

In the several embodiments provided in the present disclosure, it should be understood that the disclosed technical content may be implemented in other manners. The apparatuses described above are only exemplary. For example, the division of the units is merely a division based on logical functions and there may be other division manners in an actual implementation. For example, a plurality of units or components may be combined or integrated into another system, or some features may be ignored or not performed. In addition, the mutual coupling or direct coupling or communication connections displayed or discussed may be implemented by using some interfaces, and the indirect coupling or communication connections between the units or modules may be implemented electrically or in another form.

The units described as separate parts may or may not be physically separate. Parts displayed as units may or may not be physical units, i.e., they may be located in one position or distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit. The integrated unit may be implemented in the form of hardware or may be implemented in the form of a software functional unit.

When the integrated unit is implemented in the form of a software functional unit and sold or used as an independent product, the integrated unit may be stored in a computer readable storage medium. Based on such an understanding, the technical solutions of the present disclosure essentially, or the part making contributions to the prior art, or all or a part of the technical solutions may be implemented in the form of a software product. The computer software product is stored in a storage medium and includes several instructions for instructing a computer device (which may be a personal computer, a server, a network device or the like) to perform all or some of the steps of the methods described in the embodiments of the present disclosure. The foregoing storage medium includes: any medium that can store program codes, such as a USB flash drive, a ROM, a RAM, a removable hard disk, a magnetic disk, or an optical disc.

Described above are only preferred embodiments of the present disclosure. It should be noted that those of ordinary skill in the art can further make several improvements and modifications without departing from the principle of the present disclosure, and these improvements and modifications should also be construed as the protection scope of the present disclosure.

What is claimed is:

1. A method for executing a data recovery operation, the method comprising:
acquiring identification information of a first change log to be recovered to;
searching for the first change log according to the identification information; and
recovering a second change log to the first change log according to user data information and metadata information that are recorded in the second change log as well as user data information and metadata information that are recorded in the first change log,
wherein multiple change logs exist between the second change log and the first change log.

2. The method according to claim 1, wherein recovering the second change log further comprises:
parsing out first original user data and first original metadata from the first change log;
parsing out second original user data and second original metadata from the second change log;
recovering the second original user data to the first original user data; and
recovering the second original metadata to the first original metadata.

3. The method according to claim 1, wherein recovering the second change log further comprises:
parsing out first original user data and first original metadata from the first change log;
parsing out modified user data and modified metadata from the second change log;
recovering the modified user data to the first original user data; and
recovering the modified metadata to the first original metadata,
wherein the modified user data and the modified metadata are obtained by modifying, according to a type of an operation to modify an object recorded in the second change log, second original user data and second original metadata that are recorded in the second change log.

4. The method according to claim 1, wherein searching for the first change log further comprises:
acquiring change log list information by adding a list name into a change log query command or acquiring change log partition information by adding a partition name into a change log query command, and searching for the first change log in the change log list information or the change log partition information according to the identification information; or
searching for the first change log by adding a list name and the identification information into a change log query command or adding a partition name and the identification information into a change log query command.

5. The method according to claim 1, wherein acquiring identification information of the first change log further comprises:
receiving a control instruction for triggering the data recovery operation, wherein the control instruction carries the identification information;
performing an authentication operation on the control instruction; and
acquiring the identification information from the control instruction when the authentication operation succeeds.

6. The method according to claim 5, further comprising:
returning prompt information corresponding to the control instruction,
wherein the prompt information is used for representing that the second change log has been successfully recovered to the first change log.

7. An apparatus for executing a data recovery operation, the apparatus comprising:
a memory storing a set of instructions; and
a processor configured to execute the set of instructions to cause the apparatus to perform:
acquiring identification information of a first change log to be recovered to;
searching for the first change log according to the identification information; and
recovering a second change log to the first change log according to user data information and metadata information that are recorded in the second change log as well as user data information and metadata information that are recorded in the first change log,
wherein multiple change logs exist between the second change log and the first change log.

8. The apparatus according to claim 7, wherein the processor further executes the set of instructions to cause the apparatus to perform:
parsing out first original user data and first original metadata from the first change log; and
parsing out second original user data and second original metadata from the second change log;
recovering the second original user data to the first original user data; and
recovering the second original metadata to the first original metadata.

9. The apparatus according to claim 7, wherein the processor further executes the set of instructions to cause the apparatus to perform:
parsing out first original user data and first original metadata from the first change log; and
parsing out modified user data and modified metadata from the second change log;
recovering the modified user data to the first original user data; and
recovering the modified metadata to the first original metadata,
wherein the modified user data and the modified metadata are obtained by modifying, according to a type of an operation to modify an object recorded in the second change log, second original user data and second original metadata that are recorded in the second change log.

10. The apparatus according to claim 7, wherein the processor further executes the set of instructions to cause the apparatus to perform:
acquiring change log list information by adding a list name into a change log query command or acquiring change log partition information by adding a partition name into a change log query command; or
searching for the first change log in the change log list information or the change log partition information according to the identification information; or searching for the first change log by adding a list name and the identification information into a change log query command or adding a partition name and the identification information into a change log query command.

11. The apparatus according to claim 7, wherein the processor further executes the set of instructions to cause the apparatus to perform:
receiving a control instruction for triggering a data recovery operation, wherein the control instruction caries the identification information;
performing an authentication operation on the control instruction; and
acquiring the identification information from the control instruction when the authentication succeeds.

12. The apparatus according to claim 11, the processor further executes the set of instructions to cause the apparatus to perform:
returning a prompt information corresponding to the control instruction,
wherein the prompt information is used for representing that the second change log has been successfully recovered to the first change log.

13. A non-transitory computer readable medium that stores a set of instructions that is executable by at least one processor of a computer system to cause the computer system to perform a method for executing a data recovery operation, the method comprising:
acquiring identification information of a first change log to be recovered to;
searching for the first change log according to the identification information; and
recovering a second change log to the first change log according to user data information and metadata information that are recorded in the second change log as well as user data information and metadata information that are recorded in the first change log,
wherein multiple change logs exist between the second change log and the first change log.

14. The non-transitory computer readable medium according to claim 13, wherein the recovering further comprises:
parsing out first original user data and first original metadata from the first change log;
parsing out second original user data and second original metadata from the second change log;
recovering the second original user data to the first original user data; and
recovering the second original metadata to the first original metadata.

15. The non-transitory computer readable medium according to claim 13, wherein the recovering further comprises:
parsing out first original user data and first original metadata from the first change log;
parsing out modified user data and modified metadata from the second change log;
recovering the modified user data to the first original user data; and
recovering the modified metadata to the first original metadata,
wherein the modified user data and the modified metadata are obtained by modifying, according to a type of an operation to modify an object recorded in the second change log, second original user data and second original metadata that are recorded in the second change log.

16. The non-transitory computer readable medium according to claim 13, wherein the searching further comprises:
acquiring change log list information by adding a list name into a change log query command or acquiring change log partition information by adding a partition name into a change log query command, and searching for the first change log in the change log list information or the change log partition information according to the identification information; or
searching for the first change log by adding a list name and the identification information into a change log query command or adding a partition name and the identification information into a change log query command.

17. The non-transitory computer readable medium according to claim 13, wherein the acquiring further comprises:
receiving a control instruction for triggering a data recovery operation, wherein the control instruction carries the identification information;
performing an authentication operation on the control instruction; and
acquiring the identification information from the control instruction when the authentication succeeds.

18. The non-transitory computer readable medium according to claim 13, wherein the set of instructions that is executable by the at least one processor of the computer system to cause the computer system to further perform:
returning a prompt information corresponding to the control instruction,
wherein the prompt information is used for representing that the second change log has been successfully recovered to the first change log.
